(19) United States
(12) Patent Application Publication
(10) Pub. No.: US 2005/0042935 A1
(43) Pub. Date: Feb. 24, 2005

(54) Solderless electrical contact

(75) Inventor: Robert D. Larsen, Oakville, CT (US)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Litton Systems, Inc.

(21) Appl. No.: 10/643,962

(22) Filed: Aug. 20, 2003

(51) Int. Cl. H01R 13/42

(52) U.S. Cl. 439/751

(57) ABSTRACT

A solderless electrical contact has first and second ends for connection to conductive elements joined by a central section having a C-shaped cross-section with opposing arms tapering to a reduced end thickness for press-fit mounting into a printed circuit board aperture. The C-shaped cross-section has a slot arranged therein, the slot having a longitudinal axis parallel to a longitudinal axis of the electrical contact. The tapering arms of the C-shaped cross-section provide uniformly stressed beams that allow the radii of each arm to better conform to tolerance variations of the aperture without creating undue stresses therein and the slot arranged in the C-shaped cross-section reduces an insertion force of the electrical contact while retaining a sufficient retention force of the electrical contact.

### BACKGROUND OF THE INVENTION

1. Field of the Invention

The present invention relates to an electrical contact and, more particularly, to an electrical contact which can be inserted into an aperture within an insulated mounting board, such as a printed circuit board, for making electrical contact with conductive paths thereon without requiring soldering. The electrical contact is also utilized to make electrical contact with other conductive elements associated with the printed circuit board.

2. Description of the Related Art

In the prior art, solderless electrical contacts have been secured within plated-through holes in printed circuit boards by using a square pin in a round hole. This configuration has the disadvantage of mechanically deforming the hole upon insertion, thus making repeated insertions impractical. The square pin configuration also produces an inferior electrical connection between the electrical contact and the hole since the ambient atmosphere is free to circulate between the two, which allows a corrosive, non-conductive film to develop therebetween.

Electrical contact configurations have been proposed to reduce the degrading effect of the square pin in a round hole. See, for example, U.S. Pat. No. 3,545,080 by W. R. Evans, that issued on Dec. 8, 1970, and U.S. Pat. No. 3,824,554 by G. D. Shoholm that issued on Jul. 16, 1974.

A more practical approach for retaining an electrical contact in a plated-through hole without requiring soldering is disclosed in U.S. Pat. No. 3,783,433 by H. N. Kurtz et al., which issued on Jan. 1, 1974 and which is assigned to the same assignee as that of the present application. Kurtz et al. refers to a contact spring section that engages a plated-through hole without deforming the hole while providing a gas-tight seal therebetween for preventing deterioration of the electrical connection.

However, the spring section of the Kurtz et al. contact requires a wide spacing between the consecutively spaced contacts as they are stamped from a flat sheet of metal stock. Furthermore, the sheet metal from which the Kurtz et al. contact is formed requires a thick and thin section. To form the Kurtz et al. contact, the metal stock must be milled prior to stamping. Due to the substantial dimensional difference between the thick and thin sections, the milling requirement is a major consideration in the contact cost.

U.S. Pat. No. 4,017,143, by Robert Knowles, which issued on Apr. 12, 1977, and which is assigned to the same assignee as that of the present application, provides an improved contact which can be formed from flat sheet metal stock without a required milling step or, in some embodiments, with a reduced requirement. An electrical contact is provided with a central cross-section that can be inserted into an aperture, such as a plated-through hole of a printed circuit board, without requiring soldering. The central section can also be inserted into the plated-through hole without mechanically deforming the hole while providing a gas-tight seal between the contact and the hole. Furthermore, the central section of the contact provides a contact configuration that easily conforms to various sized apertures for providing improved mechanical and electrical contact over a wider tolerance range. Still furthermore, the configuration of the central section provides electrical contacts that are more easily fabricated and fabricated on closer centers than earlier contacts that otherwise have the same mechanical and electrical advantages.

The contact of Knowles has a central section formed with a C-shaped cross-section whose opposing arcuate arms taper toward a reduced thickness at each end thereof. This configuration provides two uniformly stressed beam sections that allow the radii of each arcuate arm to better conform to various sized apertures.

Referring to FIGS. 1-3, the solderless electrical contact of Knowles 10 has an upper cantilever section 12, a central section 14, and a lower wire-wrap tail section 16.

The cantilever section 12 is formed by a flat cantilever arm that is bifurcated by a slot 18 to form two spring arms 20 which are inwardly bowed at 22 before terminating at the uppermost ends thereof with outwardly extending tabs 24. It will be understood by reference to Kurtz et al. that equivalent upper sections can be substituted for the cantilever section 12 shown herein, including a socket section for receipt of an electrical contact extending from an integrated circuit, a rounded pin, or a square pin.

Referring to FIGS. 4 and 5, the central section 14 includes a C-shaped cross-section 26 formed by oppositely extending arcuate arms 28 which taper toward a reduced cross-sectional thickness at the ends of each arm as shown in FIG. 6.

The upper portion of the central section 14 merges with the lower portion of the cantilever section 12 at a widened stop 30 that forms upper shoulders 32. The stop 30 provides a reference for the electrical contact 10 as it is inserted into an aperture 34 in an insulated mounting board 36, such as a printed circuit board. The shoulders 32 act as a working surface against which a press, not shown, engages the contact 10 for insertion into the apertures 34 which can be arranged in two evenly spaced rows upon the board 36. Once inserted into apertures 34, with the bowed portions 22 of each contact 10 facing inwardly, the contacts will wipe against conductive paths upon a second printed circuit board, not shown, which can be inserted therebetween.

The apertures 34 in the printed circuit board 36 can include plating through the entire length of each aperture. When such plating passes through the hole, it is normally connected to a conductive boss 38 that, in turn, can connect to a conductive strip 40 for completing an electrical circuit between two boards.

Referring again to FIG. 4, it will be seen that the lower portion of the central C-shaped section 14 merges with the upper portion of the wire-wrap tail section 16 through a frustrum section 41 with the outer surface diameter of arms 28 diminishing to merge into the wire-wrap tail section 16. In the embodiment shown in FIGS. 4 and 7, the tail section 16 has a square cross-section 17 with a typical side dimension of 0.025 inches. The opposing tapered arms 28 form a slot 42 between their ends that extends into the merging section 41. This slot provides resiliency for the truncated cone-shaped merging section 41, which permits it to yield as it is inserted into aperture 34, thus preventing deformation of the apertures. Due to the absence of a truncated merging section 41, earlier contacts often deform a plated-through hole into which they are inserted even though they are designed with a wire-wrap tail section that clears the hole and a central section that minimizes the deformation of the hole.

The tapering arms 28 of central section 14 provide uniformly stressed beam sections which allow the outer diameter of the central section 14 to better conform to the inside diameter of various sized apertures 34. For example, the outer diameter of the central section can be 0.047 inches. This diameter is designed to fit without deformation into a 0.040-inch hole having a tolerance variation of +/−0.003 inches. The tolerance variation for a drilled hole can be much less. However, it should be remembered that the electrical contact of Knowles is intended to function in a drilled hole or a plated-through hole and it is desirable to have a larger tolerance range with the latter. Thus, the central section 14 can be inserted into an aperture that has a tolerance variation of +/−7.5 percent or, from another viewpoint, into an aperture that is from 8.5 to 21 percent smaller than the outer diameter of the central section 14. FIG. 8 is a cross-sectional view of the central section 14 disposed within various sized apertures.

In the electrical contact of Knowles, the wire-wrap tail section 16 can take several forms, including the square cross-section 17 of FIG. 7, or a hat-shaped cross-section 43 of FIG. 9. The hat-shaped cross-section 43 of the wire-wrap tail section 16 is formed by stamping the flat sheet metal material from which the electrical contact 10 is formed with a slot forming tool which forms a concave slot or rib 44 in one side of the rectangularly cross-sectioned wire-wrap tail 16. The tool that forms rib 44 also swages the metal on the opposite side of the tail section into a rounded cavity to form the convex upper rib portion 46. The rib 44-46 reinforces the wire-wrap tail section 43 that is thinner than section 17 to allow a conductive wire to be wrapped about it without bending.

As stated above, a typical square wire-wrap tail section 17 has a side dimension of 0.025 inches. The diagonal of this section is slightly larger than 0.035 inches, thus requiring a minimum clearance hole of 0.036 inches to allow the square wire-wrap tail section 17 to clear the aperture 34. The hat-shaped wire-wrap tail section 43 has a typical width of 0.033 inches with a diagonal of slightly less than 0.037 inches. Each of these embodiments of the wire-wrap tail section 16 will clear an aperture 34 having a nominal diameter of 0.040 inches.

The central section 14 of the contact of Knowles has an advantage over the contact of Kurtz et al. in that the amount of metal required to manufacture the C-shaped cross-section 26 is less than the amount required by the Kurtz et al. contact. This allows the contacts to be formed from a flat sheet of metal on closer centers that reduces the amount of metal scrap. If a gold inlay is to be used across the bowed portions 22 which contact a second printed circuit board, the closer contact centers reduces the gold scrap considerably. The reduced distance between centers has a further advantage of allowing the contacts to be retained upon a carry strip for multiple insertion into the apertures 34. After insertion, the carry strip can be broken away along a scoremark formed just above the tabs 24.

After inserting the electrical contacts 10 into the apertures 34 in the printed circuit board 36, an insulated housing 48 can be placed over the contacts 10 for protecting the contacts and for guiding a second printed circuit board between opposing contact rows. Referring to FIG. 1, the insulated housing includes a board-receiving slot 50 that terminates at a board stop formed by a shoulder 52. On each side of shoulder 52 are passageways 54 which extend from the upper surface of the insulated housing 48 to the lower surface thereof. The passageways 54 receive the electrical contacts 10 and open at opening 56 into the board slot 50 to allow the bowed portions 22 of the electrical contacts 10 to extend into the slot. The opening 56 is partially restricted by vertically extending strips 58 that form shoulders 60 against which tabs 24 rest for preloading the bowed portions 22 after the housing 48 has been properly positioned over the contacts 10.

The insulated housing 48 can be attached to the printed circuit board 36 by machine screws, not shown. Alternately, the flat stop portion 30 can be provided with a detent that engages a shouldered surface of a rib formed along the lower inner surface of passageway 54.

When the square wire-wrap tail section 17 of FIG. 7 is used, sheet metal stock having a thickness equal to the thickness of the square wire-wrap section is required. The simplified tapered C-shaped section 26 of the central section 14 does not require as thin a cross-section as did the Kurtz et al. central section. This allows the thicker stock to be swaged to the thinner dimension required by section 14, thus eliminating the milling step required by the Kurtz et al. contact. Once the thickness of the central section 14 is established by the swaging step, the tapering arms 28 of C-shaped section 26 can be formed by an additional coining step of FIG. 6. The flattened tapering arms 28 are then rounded through successive stages of a multi-stationed die. When the hat-shaped cross-section 43 of FIG. 9 is used, the required sheet metal stock thickness is substantially reduced. In this embodiment, the dimensional difference between the central section 14 and the tail section 43 is nominal and can be zero. It is thus possible to swage the slightly thinner section required for the central section 14 with little effort. Once the maximum thickness of the C-shaped cross-section 14 has been established, the tapered arms 28 are formed as described above.

The tapering C-shaped cross-section 26 of the electrical contact 10 described herein has many applications. It has been found that this configuration allows the manufacturer of a printed circuit board and the plated-through holes therein to utilize a large tolerance range since the arcuate tapering arms 28 conform easily with various inside diameters of the apertures 34 with which they engage. The tapering arms 28 minimize the stress build-up within the C-shaped section 26 to provide an electrical contact 10 that engages the plated-through hole of aperture 34 without deforming the hole. Further, the tapered C-shaped cross-section provides a gas-tight seal between the contact and the hole that prevents deterioration of the electrical contact made therebetween.

### SUMMARY OF THE INVENTION

While the electrical contact of Knowles has been used extensively over the years since the Knowles patent issued, a disadvantage has been noted. Namely, the insertion force needed for each electrical contact has been found to be too high for some purposes. However, past attempts at reducing the insertion force unfortunately resulted in a reduced retention force that proved to be insufficient in some cases.

To overcome the disadvantage noted above, the present inventor has found that by adding a small slot to the C-section, an electrical contact can be produced having an insertion force that is lower than the insertion force of the electrical contact of Knowles but still retains an adequate retention force.

Furthermore, the addition of the slot to the C-shaped center portion significantly reduces variations in both insertion and retention forces with respect to variations in the size of the mating aperture.

These and other objects of the present invention may be achieved by providing an electrical contact adapted for insertion into a mounting plane aperture, the electrical contact comprising: an aperture engaging section having a C-shaped cross-section formed from opposing arms, said aperture engaging section having a slot arranged therein, said slot having a longitudinal axis parallel to a longitudinal axis of the electrical contact; and said opposing arms adapted for engaging said aperture along their outer surface to the ends thereof and tapering over a circumferential arc greater than 90 degrees to a reduced cross-sectional thickness at the ends thereof.

In the electrical contact above, said C-shaped section can have an outer diameter adapted for insertion into a mounting plane aperture whose inner diameter is from 8.5 to 21 percent smaller than said outer diameter of said C-shaped section.

Furthermore, said mounting apertures can be lined with a conductive layer adapted to provide a third conductive element to which said contact can be electrically connected.

Still furthermore, said first end section can be adapted to merge into said C-shaped cross-section through a slotted truncated cone section.

In addition, said first end section can include a square cross-sectional wire-wrap tail adapted to be wrapped by said first conductive element.

In the electrical contact above, said first end section can be adapted to include a hat-shaped cross-sectional wire-wrap tail having a cross-sectional thickness slightly greater than said cross-sectional thickness of said C-shaped cross-section.

Furthermore, said first end section can be adapted to include a hat-shaped cross-sectional wire-wrap tail having a cross-sectional thickness equal to said cross-sectional thickness of said C-shaped cross-section at the thickest portion of said opposing arms.

Still furthermore, said aperture engaging section slot can comprise one of either a substantially diamond-shaped slot, said diamond-shaped slot having rounded vertices or a substantially elliptical shaped slot.

In addition, said aperture engaging section slot can have a length of 0.08 inches or have a length of 0.10 inches and can have a width of 0.01 inches.

These and other objects of the present invention can also be achieved by providing an electrical contact adapted for electrical connection to conductive elements and for insertion into an insulated board having a mounting aperture therein, the electrical contact comprising: a first end section adapted for engaging a first of the conductive elements; a second end section adapted for engagement with a second of the conductive elements; and a center section, adapted for joining said first and second end sections, and having a C-shaped cross-section formed by opposing arms that taper over a circumferential arc greater than 90 degrees to a reduced cross-sectional thickness for insertion into said insulated board mounting aperture, said center section having a slot arranged therein, said slot having a longitudinal axis parallel to a longitudinal axis of the electrical contact.

Furthermore, these and other objects of the present invention can also be achieved by providing an electrical contact adapted for insertion into an aperture, the electrical contact comprising: a C-shaped cross-section adapted for insertion into said aperture and formed from joined opposing arms having outer surfaces that engage the inner surface of said aperture along the full axial length and full circumferential width of said opposing arm surfaces, said C-shaped cross-section having a slot arranged therein, said slot having a longitudinal axis parallel to a longitudinal axis of the electrical contact; wherein said opposing arms are adapted to taper from the jointure thereof along the full circumferential width of said opposing arms to a reduced cross-sectional thickness at the ends thereof.

Still furthermore, these and other objects of the present invention can also be achieved by a method of manufacturing an electrical contact adapted for insertion into a mounting plane aperture, the method comprising: forming an aperture engaging section having a C-shaped cross-section from opposing arms; forming a slot in said aperture engaging section, said slot having a longitudinal axis parallel to a longitudinal axis of the electrical contact; and forming said opposing arms for engaging said aperture along their outer surface to the ends thereof and tapering said opposing arms over a circumferential arc greater than 90 degrees to a reduced cross-sectional thickness at the ends thereof.

In addition, these and other objects of the present invention can also be achieved by a method of manufacturing an electrical contact adapted for electrical connection to conductive elements and for insertion into an insulated board having a mounting aperture therein, the method comprising: forming a first end section adapted for engaging a first of the conductive elements; forming a second end section adapted for engagement with a second of the conductive elements; and forming a center section, adapted for joining said first and second end sections, with a C-shaped cross-section; forming said C-shaped cross-section with opposing arms that taper over a circumferential arc greater than 90 degrees to a reduced cross-sectional thickness for insertion into said insulated board mounting aperture; and forming a slot in said center section, said slot having a longitudinal axis parallel to a longitudinal axis of the electrical contact.

Lastly, these and other objects of the present invention can be achieved by a method of manufacturing an electrical contact adapted for insertion into an aperture, the method comprising: forming a C-shaped cross-section, adapted for insertion into said aperture, with joined opposing arms having outer surfaces that engage the inner surface of said aperture along the full axial length and full circumferential width of said opposing arm surfaces; forming a slot in said C-shaped cross-section, said slot having a longitudinal axis parallel to a longitudinal axis of the electrical contact; and forming said opposing arms to taper from the jointure thereof along the full circumferential width of said opposing arms to a reduced cross-sectional thickness at the ends thereof.

### BRIEF DESCRIPTION OF THE DRAWINGS

The foregoing and a better understanding of the present invention will be, parent from the following detailed description of an example embodiment and the claims when read in connection with the accompanying drawings, all forming a part of the disclosure of this invention. While the foregoing and following written and illustrated disclosure focuses on disclosing an example embodiment of the invention, it should be clearly understood that the same as by way of illustration and example only and that the present invention is not limited thereto. This spirit and scope of the present invention are limited only by the terms of the appended claims.

The following represents brief descriptions of the drawings, wherein:

FIG. 1 is a perspective view showing a prior art solderless electrical contact mounted in a printed circuit board and in an insulated housing;

FIG. 2 is a front elevational view of the electrical contact of FIG. 1;

FIG. 3 is a partial side elevational view of the electrical contact of FIG. 1;

FIG. 4 is a perspective view of the electrical contact of FIG. 1 showing its central section in cross-section;

FIG. 5 is a cross-sectional view taken along line 5-5 of FIG. 3;

FIG. 6 is a cross-sectional view of the central section shown in FIG. 5 prior to forming;

FIG. 7 is a cross-sectional view of a square wire-wrap tail shown in FIG. 4;

FIG. 8 is a cross-sectional view of the central section of FIG. 5 mounted in various sized apertures;

FIG. 9 is a cross-sectional view taken along line 9-9 of FIG. 3;

FIGS. 10-12 are partial perspective views of an embodiment of the electrical contact in accordance with the present invention; and

FIG. 13 is a view of a metal stamping used to form an electrical contact in accordance with an embodiment of the present invention.

### DETAILED DESCRIPTION

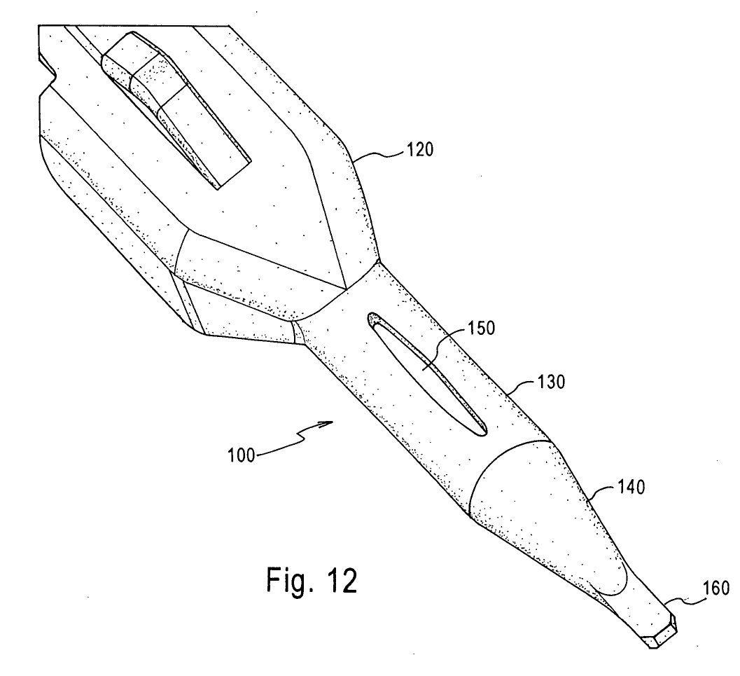

FIGS. 10-12 are partial perspective views of an embodiment of the electrical contact in accordance with the present invention. As shown therein, an electrical contact 100 includes spring arms 110, a shoulder portion 120, a C-shaped center portion 130, a tapered portion 140, and a tail section 160. Only a portion of the tail section 160 has been shown in the drawing figures for the sake of clarity.

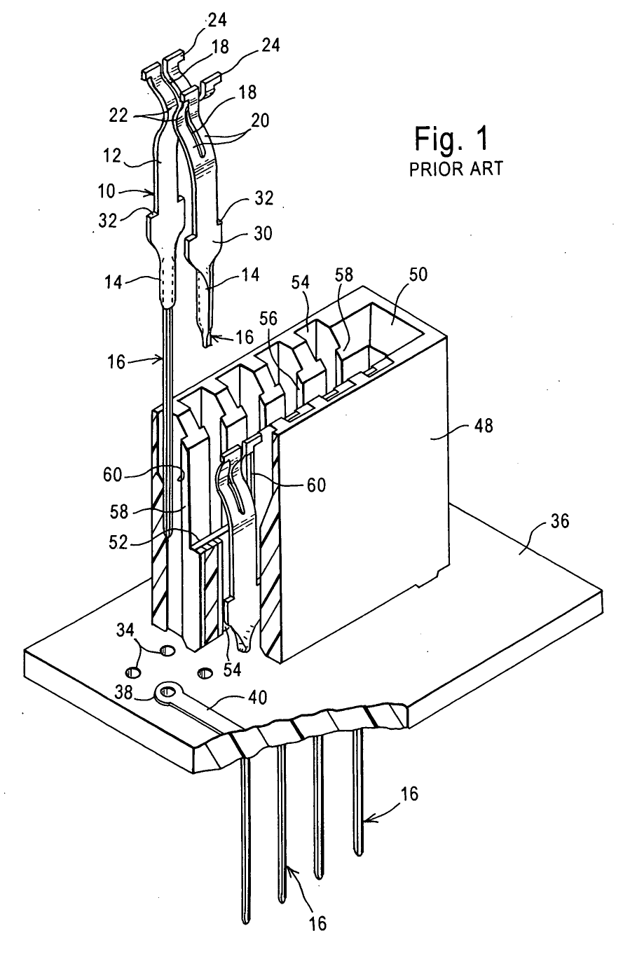

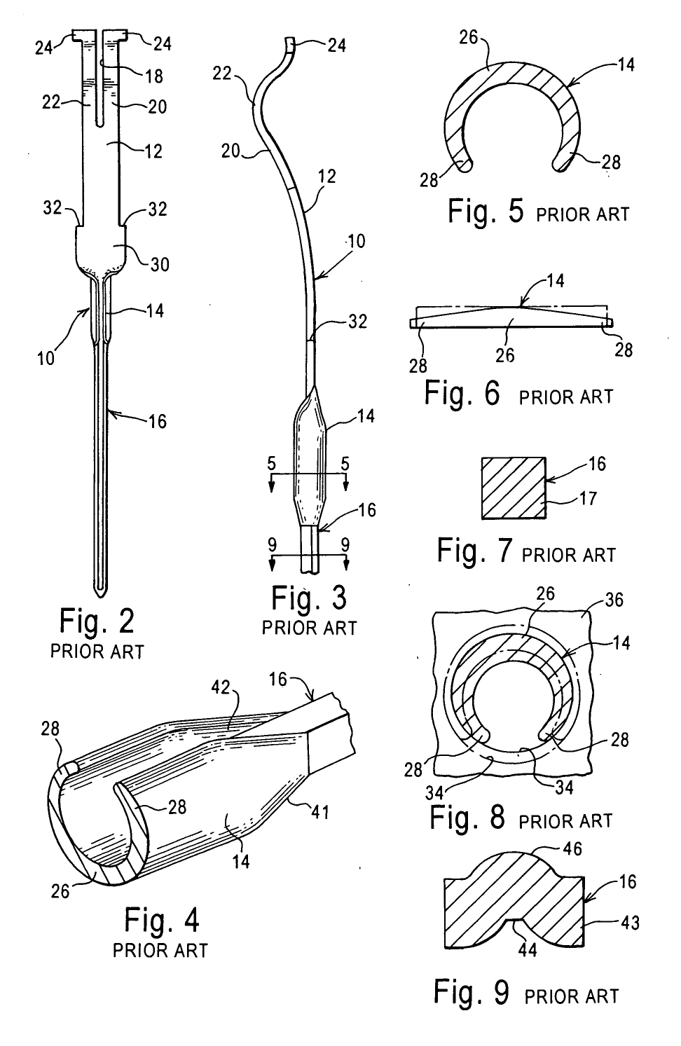

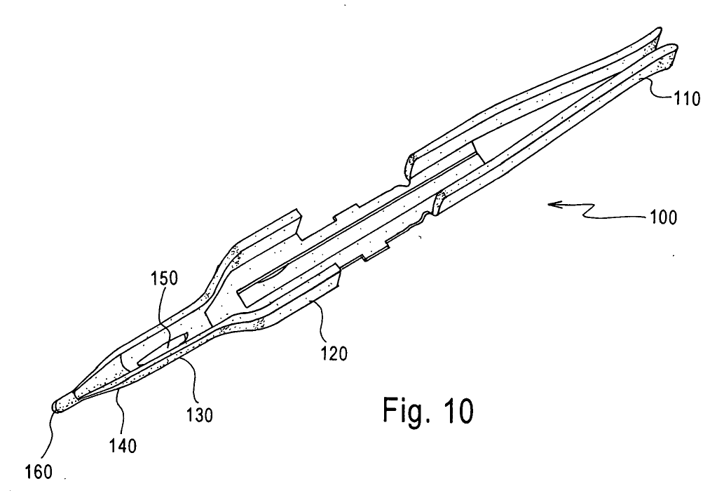

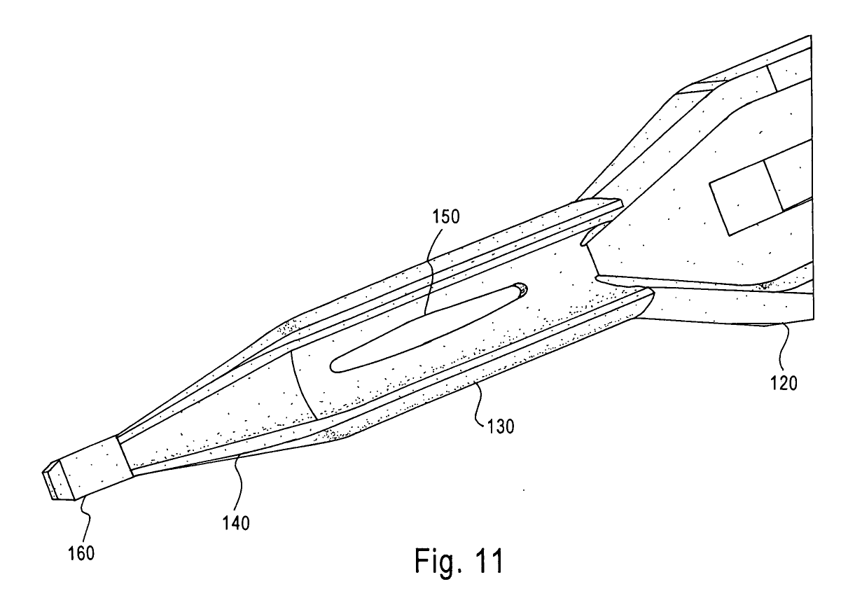

The electrical contact 100 is similar to the electrical contact of FIGS. 1-9 with the exception that a slot 150 has been added to the C-shaped center portion 130. The addition of the slot 150 to the C-shaped center portion 130 dramatically improves the mechanical characteristics of the electrical contact 100 by significantly decreasing the insertion force needed to insert the electrical contact 100 into its mating aperture while retaining an acceptable retention force needed to hold the electrical contact 100 in its mating aperture. Furthermore, the addition of the slot 150 to the C-shaped center portion 130 significantly reduces variations in both insertion and retention forces with respect to variations in the size of the mating aperture.

For example, laboratory tests were performed on the electrical contact 100 without the slot 150, with a slot 150 having a length of 0.080 inches, and with a slot 150 having a length of 0.100 inches.

The electrical contact 100 without the slot 150 had a minimum insertion force of 20.3 pounds of force for a maximum size aperture and a maximum insertion force of 24.7 pounds of force for a minimum size aperture and a retention force of 21 pounds of force.

The electrical contact 100 with a slot 150 having a length of 0.080 inches had a minimum insertion force of 16.5 pounds of force for a maximum size aperture and a maximum insertion force of 17.7 pounds of force for a minimum size aperture and a retention force of 15 pounds of force.

The electrical contact 100 with a slot 150 having a length of 0.100 inches had a minimum insertion force of 12.7 pounds of force for a maximum size aperture and a maximum insertion force of 13.9 pounds of force for a minimum size aperture and a retention force of 11.8 pounds of force.

Thus, it is clear that the addition of the slot 150 to the C-shaped center portion 130 improves the mechanical characteristics of the electrical contact 100 by significantly decreasing the insertion force needed to insert the electrical contact 100 into its mating aperture while retaining an acceptable retention force needed to hold the electrical contact 100 in its mating aperture. Furthermore, it is clear that the addition of the slot 150 to the C-shaped center portion 130 significantly reduces variations in both insertion and retention forces with respect to variations in the size of the mating aperture.

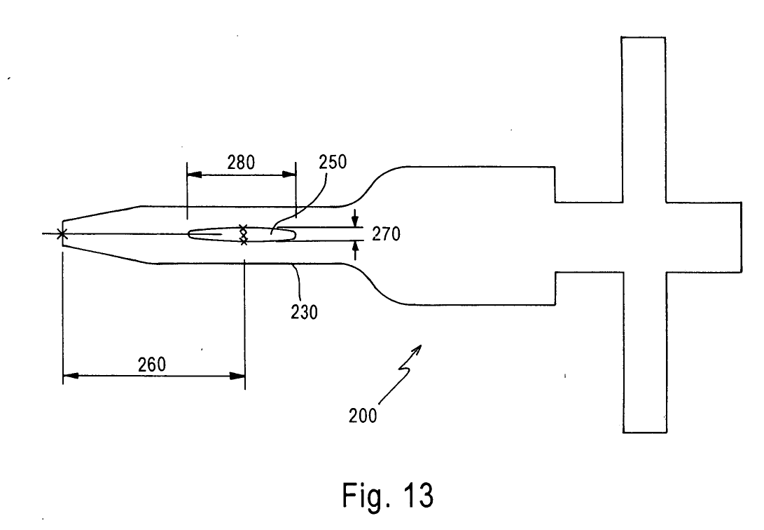

Referring to FIG. 13, the slot 250 of the metal stamping 200 is illustrated as being either almost elliptical or being diamond shaped with rounded vertices. It is to be noted that the present invention is not limited to the illustrated shape of the slots 150 or 250 but rather can be rectangular or trapezoidal or teardrop shaped, for example.

For reference, the slot 250 can have a width 270 of 0.01 inches and a length 280 of either 0.080 inches or 0.100 inches. The distance 260 between the center of the slot 250 and the end of the metal stamping 200 can be 0.130 inches. These dimensions are merely for exemplary purposes and the present invention is not limited thereto.

This concludes the description of the example embodiment. Although the present invention has been described with a reference to the example embodiment, it should be understood that numerous other modifications and embodiment can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings, and the appended claims without departing from the spirit of the invention. In addition to variations and modifications in the component parts and/or arrangements, alternative uses will also be apparent to those skilled in the art.

1. An electrical contact adapted for insertion into a mounting plane aperture, the electrical contact comprising:
an aperture engaging section having a C-shaped cross-section formed from opposing arms, said aperture engaging section having a slot arranged therein, said slot having a longitudinal axis parallel to a longitudinal axis of the electrical contact; and
said opposing arms adapted for engaging said aperture along their outer surface to the ends thereof and tapering over a circumferential arc greater than 90 degrees to a reduced cross-sectional thickness at the ends thereof.

2. The electrical contact of claim 1, wherein said C-shaped section has an outer diameter adapted for insertion into a mounting plane aperture whose inner diameter is from 8.5 to 21 percent smaller than said outer diameter of said C-shaped section.

3. The electrical contact of claim 1, wherein said mounting apertures are lined with a conductive layer adapted to provide a third conductive element to which said contact can be electrically connected.

4. The electrical contact of claim 1, wherein said first end section is adapted to merge into said C-shaped cross-section through a slotted truncated cone section.

5. The electrical contact of claim 1, wherein said first end section includes a square cross-sectional wire-wrap tail adapted to be wrapped by said first conductive element.

6. The electrical contact of claim 1, wherein said first end section is adapted to include a hat-shaped cross-sectional wire-wrap tail having a cross-sectional thickness slightly greater than said cross-sectional thickness of said C-shaped cross-section.

7. The electrical contact of claim 1, wherein said first end section is adapted to include a hat-shaped cross-sectional wire-wrap tail having a cross-sectional thickness equal to said cross-sectional thickness of said C-shaped cross-section at the thickest portion of said opposing arms.

8. The electrical contact of claim 1, wherein said aperture engaging section slot comprises one of either a substantially diamond-shaped slot, said diamond-shaped slot having rounded vertices or a substantially elliptical slot.

9. The electrical contact of claim 1, wherein said aperture engaging section slot has a length of 0.08 inches.

10. The electrical contact of claim 8, wherein said aperture engaging section slot has a length of 0.08 inches.

11. The electrical contact of claim 1, wherein said aperture engaging section slot has a length of 0.10 inches.

12. The electrical contact of claim 8, wherein said aperture engaging section slot has a length of 0.10 inches.

13. The electrical contact of claim 1, wherein said aperture engaging section slot has a width of 0.01 inches.

14. The electrical contact of claim 8, wherein said aperture engaging section slot has a width of 0.01 inches.

15. The electrical contact of claim 9, wherein said aperture engaging section slot has a width of 0.01 inches.

16. The electrical contact of claim 10, wherein said aperture engaging section slot has a width of 0.01 inches.

17. The electrical contact of claim 11, wherein said aperture engaging section slot has a width of 0.01 inches.

18. The electrical contact of claim 12, wherein said aperture engaging section slot has a width of 0.01 inches.

19. An electrical contact adapted for electrical connection to conductive elements and for insertion into an insulated board having a mounting aperture therein, the electrical contact comprising:
a first end section adapted for engaging a first of the conductive elements;
a second end section adapted for engagement with a second of the conductive elements; and
a center section, adapted for joining said first and second end sections, and having a C-shaped cross-section formed by opposing arms that taper over a circumferential arc greater than 90 degrees to a reduced cross-sectional thickness for insertion into said insulated board mounting aperture, said center section having a slot arranged therein, said slot having a longitudinal axis parallel to a longitudinal axis of the electrical contact.

20. An electrical contact adapted for insertion into an aperture, the electrical contact comprising:
a C-shaped cross-section adapted for insertion into said aperture and formed from joined opposing arms having outer surfaces that engage the inner surface of said aperture along the full axial length and full circumferential width of said opposing arm surfaces, said C-shaped cross-section having a slot arranged therein, said slot having a longitudinal axis parallel to a longitudinal axis of the electrical contact;
wherein said opposing arms are adapted to taper from the jointure thereof along the full circumferential width of said opposing arms to a reduced cross-sectional thickness at the ends thereof.

21. A method of manufacturing an electrical contact adapted for insertion into a mounting plane aperture, the method comprising:
forming an aperture engaging section having a C-shaped cross-section from opposing arms;
forming a slot in said aperture engaging section, said slot having a longitudinal axis parallel to a longitudinal axis of the electrical contact; and
forming said opposing arms for engaging said aperture along their outer surface to the ends thereof and tapering said opposing arms over a circumferential arc greater than 90 degrees to a reduced cross-sectional thickness at the ends thereof.

22. The method of claim 21, further comprising forming said C-shaped section to have an outer diameter adapted for insertion into a mounting plane aperture whose inner diameter is from 8.5 to 21 percent smaller than said outer diameter of said C-shaped section.

23. The method of claim 21, further comprising lining said mounting apertures with a conductive layer adapted to provide a third conductive element to which said contact can be electrically connected.

24. The method of claim 21, further comprising forming said first end section to merge into said C-shaped cross-section through a slotted truncated cone section.

25. The method of claim 21, further comprising forming said first end section with a square cross-sectional wire-wrap tail adapted to be wrapped by said first conductive element.

26. The method of claim 21, further comprising forming said first end section with a hat-shaped cross-sectional wire-wrap tail having a cross-sectional thickness slightly greater than said cross-sectional thickness of said C-shaped cross-section.

27. The method of claim 21, further comprising forming said first end section with a hat-shaped cross-sectional wire-wrap tail having a cross-sectional thickness equal to said cross-sectional thickness of said C-shaped cross-section at the thickest portion of said opposing arms.

28. The method of claim 21, further comprising forming said aperture engaging section slot as one of either a substantially diamond-shaped slot, said diamond-shaped slot having rounded vertices or a substantially elliptical shaped slot.

29. The method of claim 21, further comprising forming said aperture engaging section slot to have a length of 0.08 inches.

30. The method of claim 28, further comprising forming said aperture engaging section slot to have a length of 0.08 inches.

31. The method of claim 21, further comprising forming said aperture engaging section slot to have a length of 0.10 inches.

32. The method of claim 28, further comprising forming said aperture engaging section slot to have a length of 0.10 inches.

33. The method of claim 21, further comprising forming said aperture engaging section slot to have a width of 0.01 inches.

34. The method of claim 28, further comprising forming said aperture engaging section slot to have a width of 0.01 inches.

35. The method of claim 29, further comprising forming said aperture engaging section slot to have a width of 0.01 inches.

36. The method of claim 30, further comprising forming said aperture engaging section slot to have a width of 0.01 inches.

37. The method of claim 31, further comprising forming said aperture engaging section slot to have a width of 0.01 inches.

38. The method of claim 32, further comprising forming said aperture engaging section slot to have a width of 0.01 inches.

39. A method of manufacturing an electrical contact adapted for electrical connection to conductive elements and for insertion into an insulated board having a mounting aperture therein, the method comprising:
forming a first end section adapted for engaging a first of the conductive elements;
forming a second end section adapted for engagement with a second of the conductive elements; and
forming a center section, adapted for joining said first and second end sections, with a C-shaped cross-section;
forming said C-shaped cross-section with opposing arms that taper over a circumferential arc greater than 90 degrees to a reduced cross-sectional thickness for insertion into said insulated board mounting aperture; and
forming a slot in said center section, said slot having a longitudinal axis parallel to a longitudinal axis of the electrical contact.

40. A method of manufacturing an electrical contact adapted for insertion into an aperture, the method comprising:
forming a C-shaped cross-section, adapted for insertion into said aperture, with joined opposing arms having outer surfaces that engage the inner surface of said aperture along the full axial length and full circumferential width of said opposing arm surfaces;
forming a slot in said C-shaped cross-section, said slot having a longitudinal axis parallel to a longitudinal axis of the electrical contact; and
forming said opposing arms to taper from the jointure thereof along the full circumferential width of said opposing arms to a reduced cross-sectional thickness at the ends thereof.
